(19) United States
(12) Patent Application Publication
(10) Pub. No.: US 2026/0133754 A1
(43) Pub. Date: May 14, 2026

(54) Dialogue generation system and method reflecting the position of characters in a virtual space

(71) Applicant: SOULX Co., Ltd., Seoul (KR)

(72) Inventor: Young-taeck Hwang, Goyang-si (KR)

(73) Assignee: SOULX Co., Ltd., Seoul (KR)

(21) Appl. No.: 18/951,848

(22) Filed: Nov. 19, 2024

(30) Foreign Application Priority Data
Nov. 12, 2024 (KR) 10-2024-0160156

(51) Int. Cl. G06F 3/16; G06F 3/01; G06F 40/20

(52) U.S. Cl. CPC G06F 3/167; G06F 3/011; G06F 40/20

(57) ABSTRACT

Disclosed herein are a dialogue generation system that reflects the location of a character within a virtual space, and a dialogue generation system that provides a more immersive and richer dialogue experience to a user by providing metadata including location information of objects within a virtual space to an API server together with a user's query at the time the user's query is received, thereby enabling a generative AI model to generate more natural and contextual dialogue by considering the character's location.

### TECHNICAL FIELD

The present invention relates to a technology for providing a dialogue service with a character in a virtual space, and more specifically, to a dialogue generation system and method where the character placed in the virtual space generate a dialogue by reflecting information about the space where the character is placed and surrounding objects.

### DESCRIPTION OF RELATED ART

In recent years, together with the development of virtual reality (VR) and augmented reality (AR) technologies, various interaction systems within virtual spaces have been developed. These virtual spaces have been utilized in diverse fields, including games, social networks, education, and entertainment. One of the key features of virtual spaces is the interaction between users and characters. Specifically, dialogues with characters within virtual spaces help users experience more immersive and realistic environments.

Conventional dialogue generation systems mainly adopted a method of returning pre-set answers or reacting according to predetermined scenarios in response to user queries. This resulted in limitations, such as restricted responses to user queries and a lack of realism due to the inability to reflect the location of characters or the surrounding circumstances in the virtual space. For example, even if a user asks a character about the current location or surrounding environment, the system would simply provide a text-based, general response, thereby diminishing the user experience.

Thus, conventional technologies have limitations in enhancing the naturalness and realism of dialogues because they do not reflect the location information of characters and other objects in the virtual space. For a more immersive and interactive experience between users and characters, appropriate responses based on the location of characters and surrounding objects in the virtual space at the time the user's query is received are necessary. However, such location-based response systems have not been sufficiently implemented in conventional technologies, resulting in limitations where the character's responses do not reflect the context of the actual space with which the user is interacting.

### PRIOR ART

### Patent

(Patent Document 1) Korean Registered Patent No. 10-2714913

### SUMMARY

### Technical Problem

The present invention aims to provide a dialogue generation system and method that allow for the generation of responses reflecting the location information of characters and objects placed within a virtual space when receiving a user's query directed at a virtual space character, thereby providing users with a more immersive and richer dialogue experience. The problems addressed by the invention are not limited to those mentioned above; other unmentioned problems will be clearly understood by those skilled in the art from the description below.

### Means for Solving the Problem

One aspect of the present invention is a dialogue generation method comprising the steps of: generating a virtual space with characters and objects placed on a map and providing it to a user terminal; receiving a user's query targeting the character from the user terminal; acquiring location information of the characters and objects placed in the virtual space at the time the user's query is received; transmitting metadata including the user's query and the obtained location information of the characters and objects to an API server; receiving a response to the user's query from the API server; and providing the received response to the user terminal. The response is generated by a generative AI model that receives the user's query, the metadata, and the character's persona information from the API server, thus being generated based on the character's location information in the virtual space.

The internal space of the virtual space map is partitioned by at least one trigger box in the shape of a rectangular box. The method further includes a step of determining the trigger box in which the character is located based on the obtained location information of the character. The specific information of the determined trigger box where the character is located is transmitted to the API server together with the user's query and the metadata. The response is generated by a generative AI model that receives the user's query, the metadata, the character's persona information, and the specific information of the trigger box where the character is located from the API server, and thus can be generated based on the specific information of the trigger box where the character is located.

The trigger box's specialized information includes data relating to non-visual elements associated with the space inside the trigger box, which are not visually discernible on the virtual space map.

Further includes determining a trigger weight that indicates the extent to which the specialized information of the trigger box, in which the character is located, is reflected when generating the response by the generative AI model,
, and the determined trigger weight can be transmitted to the API server together with the specialized information of the trigger box in which the character is located.

The trigger weight may be determined based on the ratio of the character's total volume to the volume of the character contained within the trigger box in which the character is located.

The trigger weight may be further determined based on the ratio of the map's total volume to the volume of the trigger box in which the character is located.

The internal space of the virtual space map is partitioned by two trigger boxes or more, at least two of which overlap. In the step of determining the trigger box where the character is located based on the obtained location information of the character, if the character is determined to be located within an overlapping region of at least two trigger boxes, the trigger weight for the specialized information of each trigger box where the character is located is determined in inverse proportion to the volume of each trigger box where the character is located.

Another aspect of the present invention is a dialogue generation system including: a Virtual Space Creation Server that generates a virtual space with characters and objects arranged on a map, provides the virtual space to a user terminal, and upon receiving a user's query directed at a character from the user terminal, obtains the location information of the character and objects in the virtual space at the time the user's query is received, and transmits metadata including the user's query and the obtained location information of the character and objects to an API server; an API server that transmits the user's query and the metadata including the location information of the character and objects received from the Virtual Space Creation Server to a generative AI model together with the character's persona information; and a generative AI model that generates a response to the user's query based on the user's query, the metadata, and the character's persona information received from the API server and returns the generated response to the API server.

### Effects of the Invention

The location information of objects in the virtual space is provided to the API server together with the user's query at the time the query is received. This enables the generative AI model to consider the character's location and generate more natural and contextual dialogues, thereby providing the user with a more immersive and enriched dialogue experience. The effects of the present invention are not limited to the effects mentioned above, and other effects that are not explicitly stated can be clearly understood by those skilled in the art from the description of the claims.

### BRIEF DESCRIPTION OF THE DRAWINGS

FIG. 1 is a block diagram illustrating the configuration of the dialogue generation system according to an embodiment of the present invention.

FIG. 2 is a block diagram illustrating the configuration of the Virtual Space Creation Server depicted in FIG. 1.

FIG. 3 is a flowchart illustrating the dialogue generation method according to an embodiment of the present invention.

FIG. 4 is an illustration showing the virtual space and the characters arranged therein of the present invention.

FIG. 5 is an illustration showing the addition of assets in the virtual space according to an embodiment of the present invention.

FIG. 6 is an illustration showing the setup of a trigger box in the virtual space according to an embodiment of the present invention.

FIG. 7 is a flowchart illustrating the dialogue generation method according to another embodiment of the present invention.

FIG. 8 is an illustration showing the setup of a trigger box in the virtual space according to another embodiment of the present invention.

### DETAILED DESCRIPTION

The present invention is not limited to the embodiments described below, but can be implemented in various different forms, and these embodiments are merely examples of the contents of the present invention, and are provided to inform those with ordinary knowledge in the technical field to which the present invention belongs in detail of the scope of the invention, and the present invention is defined only by the scope of the claims. The same reference numerals refer to the same components throughout the specification.

The embodiments described herein will be described with reference to cross-sectional and/or plan views, which are ideal examples of the present invention. In the drawings, the illustrated regions are expressed for effective explanation of the technical contents. Accordingly, the regions illustrated in the drawings have a schematic nature, and the shapes of the regions illustrated in the drawings are intended to illustrate specific shapes of the element regions and are not intended to limit the scope of the invention. Although the terms first, second, third, etc. have been used in various embodiments of the present specification to describe various components, these components should not be limited by these terms. These terms are only used to distinguish one component from another. The embodiments described and illustrated herein also include complementary embodiments thereof.

The terminology used herein is for the purpose of describing embodiments and is not intended to limit the invention. In this specification, the singular includes the plural unless specifically stated otherwise. The terms “comprises” and/or “comprising” as used in the specification do not exclude the presence or addition of one or more other components, steps, operations, and/or elements to the mentioned components, steps, operations, and/or elements.

Unless otherwise defined, all terms (including technical and scientific terms) used in this specification may be used with a meaning that can be commonly understood by a person of ordinary skill in the art to which the present invention belongs. In addition, terms defined in commonly used dictionaries shall not be interpreted ideally or excessively unless explicitly specifically defined.

The embodiment of the present invention described below relates to a dialogue generation system and method reflecting the location of a character in a virtual space. Hereinafter, the dialogue generation system reflecting the location of a character in a virtual space may be briefly referred to as a dialogue generation method reflecting the location of my character. Hereinafter, with reference to the drawings, the concept of this invention and its embodiments will be described in detail.

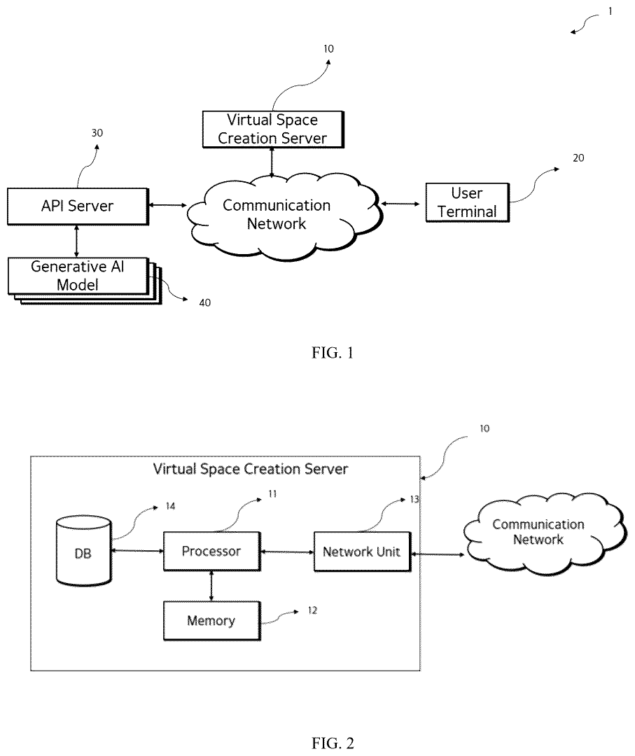

FIG. 1 is a drawing illustrating a dialogue generation system 1 according to one embodiment of the present invention. Referring to FIG. 1, the dialogue generation system 1 according to the present embodiment is composed of a Virtual Space Creation Server 10, a user terminal 20, an API server 30, and a generative AI model 40. The Virtual Space Creation Server 10, the user terminal 20, and the API server 30 are connected to each other such that they can communicate with each other through a communication network. At this time, the communication network can be configured regardless of the communication mode, such as wired and wireless, and can be implemented in various forms such that communication between servers and servers and communication between servers and terminals can be performed.

The Virtual Space Creation Server 10 implements the virtual space and the characters and assets placed in the virtual space on the user terminal 20. More specifically, when the Virtual Space Creation Server 10 receives a request for creating a virtual space from a user, it implements a map of the virtual space and a character placed in the virtual space in response to the user's request. Thereafter, when receiving a query from a user, metadata related to the virtual space is transmitted to the API server 30 together with the user's query in order to generate a response based on the location of the character placed in the virtual space, thereby obtaining a natural response reflecting the location of the character. Referring to FIG. 2, which illustrates a configuration diagram of the Virtual Space Creation Server 10 according to an embodiment of the present invention, the Virtual Space Creation Server 10 according to the present embodiment is composed of a processor 11, a memory 12, a network unit 13, and a database 14.

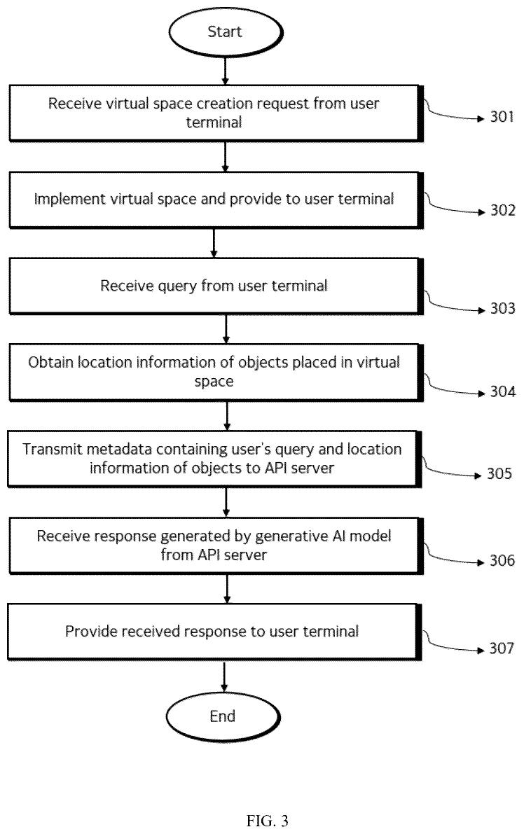

The processor 11 is a kind of central processing unit that controls the entire process supporting the virtual space provision server. Here, the processor 11 may include all kinds of devices capable of processing data, such as a processor. Here, ‘processor’ can refer to a data processing device embedded in hardware, which has physically structured circuits to perform functions represented by code or commands included within a program. As an example of a data processing device built into hardware, it may include processing devices such as a microprocessor, a central processing unit (CPU), a processor core, a multiprocessor, an ASIC (application-specific integrated circuit), and an FPGA (field programmable gate array), but the scope of the present invention is not limited thereto. Each step performed by the processor 11 according to the present embodiment will be described later with reference to FIG. 3, which shows a flow chart of a dialogue generation method according to the present embodiment.

The memory 12 can store a program for the steps of the processor 11 and can also temporarily or permanently store input/output data.

The network unit 13 may include a wired/wireless internet module for network access. The network unit 13 may perform communication with at least one of the nodes included in the blockchain network. Wireless Internet technologies may include WLAN (Wireless LAN) (Wi-Fi), Wibro (Wireless broadband), Wimax (World Interoperability for Microwave Access), HSDPA (High Speed Downlink Packet Access), etc. Wired internet technologies can include XDSL (Digital Subscriber Line), FTTH (Fiber to the Home), and PLC (Power Line Communication), etc.

The database 14 can store information such as authentication, account information, and authority management of users who use the virtual space provision service according to the present embodiment. Meanwhile, the database 14 according to the embodiment can store map information of various virtual spaces that the user can select. The map information can include information on at least one of background images that serves as the background of the map, at least one object 112 that is automatically placed with the background image when the user selects the map 110, a character 111, and at least one trigger box T that divides the map. In addition, the database 14 can store metadata that represents properties such as shape, texture, and color of each object 112 and character 111.

The components described above are exemplary, and the scope of the present invention is not limited to the components described above. That is, additional components may be included or some of the components described above may be omitted depending on the implementation aspect of the embodiments of the invention.

The user terminal 20 is an interface through which the user receives virtual space services through the Virtual Space Creation Server 10 and interacts with the virtual space. The user terminal 20 receives requests from the user, such as requests for virtual space creation and queries, and transmits them to the Virtual Space Creation Server 10. The user terminal 20 may be various electronic devices including a display section in which the virtual space implemented by the Virtual Space Creation Server 10 can be visually expressed. For example, the user terminal 20 may be one of various devices capable of communicating with the Virtual Space Creation Server 10, such as a smartphone, tablet, laptop, or desktop computer.

The API server (Application Programming Interface server) 30 mediates between the Virtual Space Creation Server 10 or the user terminal 20 and the generative AI model 40. The API server 30 receives a request from the Virtual Space Creation Server 10 or the user terminal 20 and transmits the received request to the generative AI model 40 that can process the received request. When the API server 30 receives a query from the Virtual Space Creation Server 10, it transmits the received user's query and the character's persona information to the conversational AI model among the generative AI models such that a response reflecting the character's persona can be received. In an embodiment of the invention, when the API server 30 receives metadata about the location of objects (e.g., characters, objects, and 3D assets placed in the virtual space) in the virtual space together with a user's query from the Virtual Space Creation Server 10, it transmits such metadata together with the user's query and the character's persona information to the generative AI model 40, thereby enabling the generation of a response reflecting the location of the character in the virtual space.

Meanwhile, in another embodiment, when the API server 30 receives a request for generating a visual asset (e.g., a 3D model, etc.) from the Virtual Space Creation Server 10 or the user terminal 20, it transmits the request to the digital asset AI model among the generative AI models, receives the visual asset generated from the digital asset AI model, and transmits it to the Virtual Space Creation Server 10, thereby enabling the visual asset requested by the user to be implemented on the user terminal. That is, when the API server 30 receives a user's query from the Virtual Space Creation Server 10, it transmits data for generating a response to the query to the conversational AI model, and when it receives a request for generating a visual asset from the Virtual Space Creation Server 10 or the user terminal 20, it provides information for generating a digital asset to the digital asset AI model. That is, the API server 30 can select an AI model capable of generating a response appropriate to the request based on the request received from the Virtual Space Creation Server 10 or the user terminal 20.

Thereafter, when the API server 30 receives a response from the generative AI model 40, it returns it to the Virtual Space Creation Server 10, thereby allowing the generation result by the generative AI model 40 to be delivered to the user.

The generative AI model 40 generates a response based on data received from the API server. The generative AI model 40 according to the embodiment may include models capable of various tasks related to natural language generation (i.e., conversational AI models), such as OpenAI's GPT series (GPT-3, GPT-4), Google's LaMDA, and Anthropic's Claude, as well as models capable of various tasks related to 2D and 3D asset generation, such as OpenAI's DALL-E, Stability AI's Stable Diffusion, and Midjourney's Midjourney (i.e., digital asset AI models).

FIG. 3 is a flow chart of a dialogue generation method performed by a processor of a Virtual Space Creation Server 10 according to an embodiment of the present invention. Referring to FIG. 3, in the dialogue generation method according to the present embodiment, at step 301, the Virtual Space Creation Server 10 receives a virtual space creation request from a user terminal 20. In this step, the virtual space creation request received from the user terminal 20 may include at least one of information on a map 110 and a character 111 of a virtual space that the user wishes to implement.

The virtual space map 110 is an image that serves as the background of the virtual space and represents an image of the space where the character 111 exists. For example, the virtual space map 110 can express a realistic or unrealistic space such as a school, a jungle, a different world, a snow field, and a mart.

Meanwhile, each virtual space map 110 may include at least one object 112. For example, in a classroom map, objects that can be easily seen in a classroom, such as desks, chairs, blackboards, windows, and electric fans, may be included as objects 112. The database 14 of the Virtual Space Creation Server 10 may store information and data necessary to implement a map 110 of a virtual space selected by a user, such as the visible image information of each map 110 and the location information of the location where each object 112 is expressed in the virtual space, i.e., the coordinate information of each object 112. In addition, various invisible information related to the map 110 may be stored in the database 14. For example, in the case of a jungle map, various invisible information that cannot be obtained from the visible information of the map 110, such as the weather being very hot and humid or the likelihood of many snakes, can be stored in connection with the map 110. In the case of a classroom map, invisible information, such as the classroom being very noisy or the smell of sweat after physical education, can be stored in connection with the map 110.

Meanwhile, a character 111 is a person or entity implemented in a virtual space. The character 111 can interact with a user in the virtual space. Information for implementing various types of characters that can be selected by the user can be stored in the database 14 of the Virtual Space Creation Server 10.

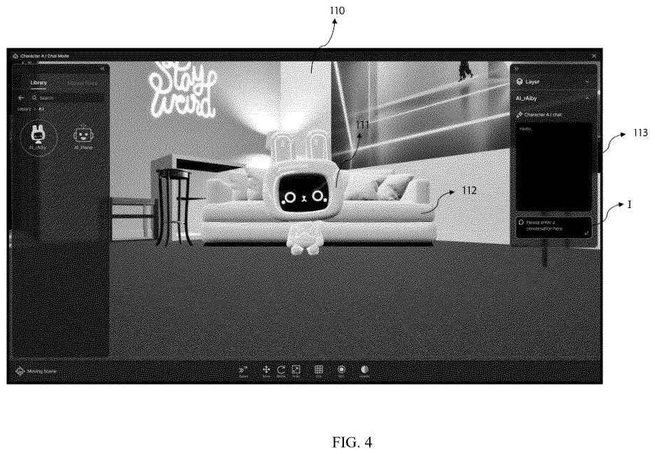

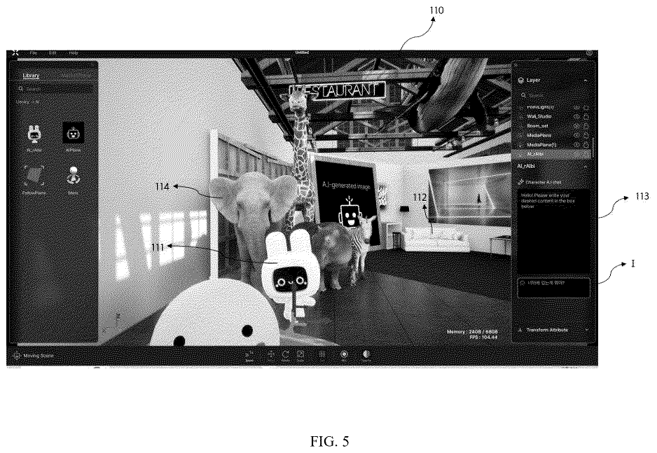

In step 302, the Virtual Space Creation Server 10 implements a virtual space according to the virtual space creation request received from the user terminal 20 in step 301 and provides it to the user terminal 20. FIG. 4 is an example of a virtual space implemented by the virtual space creation server 10 and displayed on the user terminal 20 according to one embodiment of the present invention. FIG. 4 illustrates a virtual space implemented by a virtual space creation server 10 in response to a request from a user terminal 20 at step 301 to create a ‘living room’ as a virtual space map 110 and a ‘cyber rabbit’ as a character. Looking at FIG. 4 with reference to the virtual space creation server 10, it can be confirmed that a living room map is implemented and that the living room map includes objects 112 such as a sofa, table, and chair. Meanwhile, a cyber rabbit-shaped character selected by the user is created and placed in the virtual space.

In one embodiment of the present invention, each object 112 included in the map 110 is implemented together when each map 110 is implemented, and is placed in a designated location within the map 110 according to the location information stored in the database 14 when the initial map is implemented, and can be relocated to a location desired by the user by the user's selection. In another embodiment of the present invention, each object 112 included in the map 110 has location metadata in the virtual space, but may exist only as a background image of the map 110 and may not be able to be changed in location by the user. Meanwhile, the character 111 can be moved in the virtual space by the user. Since the implementation of such a virtual space and the movement of the object 112 and the character in the virtual space are techniques known to those with common knowledge in the technical field to which the present embodiment belongs, a detailed description will be omitted in order to prevent the features of the present embodiment from being obscured.

In an embodiment of the present invention, a user can transmit a request for generating a virtual space including both a map 110 and a character 111 through a user terminal 20, and can first request the generation of a map 110 and then request the generation of a character 111. In addition, it is also possible to implement a character 111 in a virtual space and then select a map 110 that one likes to implement a background.

In this embodiment, a dialogue window 113 that allows dialogue with a character in the virtual space may be floated in the virtual space implemented by the virtual space creation server 10. A user may have a dialogue with a character 111 in the virtual space by entering a question into the dialogue window 113 through a user terminal 20.

In one embodiment of the present invention, a user may request virtual space creation by selecting at least one of a plurality of maps 110 and a plurality of characters 111 listed in advance for selection. In this case, the virtual space creation server 10 that receives the selection of the map 110 and character 111 by the user from the user terminal 20 may generate a virtual space using the information of the map 110 and character 111 that are stored in the database 14 and provide the virtual space to the user terminal 20.

In another embodiment of the present invention, the user may directly input a desired map 110 through text. For example, the user may input a request such as “Generate a lion character with a jungle with a river flowing in the background” on the interface for generating a map 110 and a character 111. In this way, the virtual space creation server 10 that receives the text-type creation request extracts keywords (e.g., river, jungle, lion) from the received text, and if the information on the map 110 and the character 111 that match the extracted keywords are stored in the database 14, the virtual space can be generated using this. Meanwhile, if the information on the map 110 and the character 111 that match the database 14 are not stored, the keywords extracted from the user's request may be transmitted to the API server 30, thereby allowing the map 110 and the character 111 to be generated by the generative AI model 40.

Meanwhile, the user can also add various 3D assets within the map 110 of the virtual space. For example, the user can add a desired type of asset 114, such as a hamburger, a giraffe, or a snowman, to the virtual space where the living room map 110 is implemented. Referring to FIG. 5, which illustrates the appearance of assets added to the virtual space, it can be confirmed that 3D assets, such as a giraffe and a zebra, have been added to the living room map of FIG. 4. Such 3D assets can be generated by the digital asset AI model when the virtual space creation server 10 receives a request to add a 3D asset from the user terminal 20 and transmits it to the API server 30. The added asset 114 can be freely placed by the user in the virtual space map 110.

In step 303, the virtual space creation server 10 receives a query from the user terminal 20. In step 302, the user can transmit a query to the virtual space creation server 10 by entering a query into the input interface (I) included in the dialogue window (113) included in the virtual space provided by the virtual space creation server 10. At this time, the query received from the user terminal 20 may be a query that requires consideration of the location of the character 111 in the virtual space and location information with other objects in order to output a more natural response. For example, the virtual space creation server 10 may receive a query from the user terminal 20 asking, “What is behind you now?” In order to naturally answer such a user's query, location information of the character and other objects in the virtual space is required.

In step 304, the virtual space creation server 10 that received the query from the user terminal 20 in step 303 obtains the location information of the character 111, object 112, and asset 114 placed in the virtual space at the time of receiving the query. In this embodiment, the location information includes not only the coordinate information of each object (i.e., the character 111, object 112, and asset 114) in the virtual space, but also the direction information indicating the direction in which each object is facing.

In step 305, the virtual space creation server 10 transmits metadata including the location information of each object obtained in step 304 and the related information of each object in the virtual space (e.g., information about the color and texture of the object) stored in the database 14 to the API server 30 together with the user's query received from the user terminal 20 in step 303. In this way, the virtual space creation server 10 transmits metadata including the location information of each object in the virtual space to the API server 30 as well as the user's query, thereby allowing the generative AI model 40 to generate a more natural response that takes into account the location of each object.

The API server 30, which receives metadata including location information of each object in the virtual space from the virtual space creation server 10, transmits the persona information of the character in the virtual space to the generative AI model 40 together with the metadata of each object received from the virtual space creation server 10. Accordingly, the generative AI model 40 can generate an answer reflecting the persona and location information of the character 111 in the virtual space. In this embodiment, the persona information of the character transmitted by the API server 30 to the generative AI model 40 can include information such as the character's personality traits, emotional expressions, behavior patterns, speech tone and dialogue styles, as well as the character's beliefs and values.

For example, referring to the virtual space illustrated in FIG. 5, if the query received by the virtual space creation server 10 from the user terminal 20 at step 303 is “What is behind you now?”, the generative AI model 40 can analyze the metadata of each object received from the API server 30 to determine the direction in which the character 111 is looking and determine that the object behind the character 111 is an “elephant”. Thereafter, the generative AI model 40 can generate a response based on the persona information of the character 111 received together with the metadata of each object from the API server 30.

If the persona information of the character 111 received from the API server 30 indicates that the character in the virtual space has an energetic and extroverted personality trait, the generative AI model 40 can generate a response such as “Oh my! Surprise! That's a big elephant!!” as a response. If the persona information of the character 111 received from the API server 30 indicates that the character in the virtual space has a calm and quiet personality trait, the generative AI model 40 can generate a response such as “Oh, that's an elephant behind me. It's quite big.”

In this way, the response generated by the generative AI model 40 is transmitted to the Virtual Space Creation Server 10 via the API server 30.

In step 306, the virtual space creation server 10 receives a response generated by the generative AI model 40 from the API server 30 based on the user's query transmitted in step 305 and metadata including location information of each object.

At step 307, the virtual space creation server 10 can provide the user with an experience of actually conversing with a character 111 in the virtual space by providing a response from the generative AI model 40 received at step 306 to the dialogue window of the user terminal 20.

In this way, the dialogue generation method according to the present embodiment does not simply provide the user's query to the API server 30, but provides metadata including information on each object placed in the virtual space at the time the user's query is received to the API server 30 together with the user's query, thereby allowing the generative AI model 40 to generate a response reflecting the character's location. Accordingly, a more realistic dialogue experience can be provided to the user.

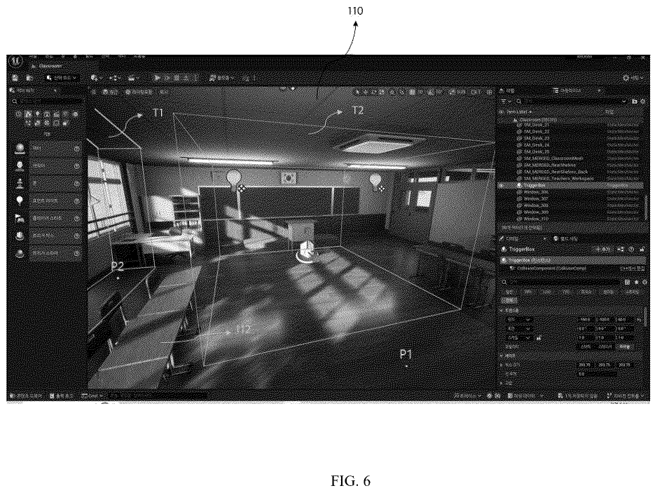

Meanwhile, in one embodiment of the present invention, a map 110 generated by a Virtual Space Creation Server 10 may have at least one trigger area set in the internal space that has a volume smaller than the entire volume of the map 110. Each trigger area is formed by a trigger box T having a rectangular box shape. FIG. 6 illustrates a state in which a trigger area is set by two trigger boxes T1, T2 in a map 110 according to one embodiment of the present invention. Referring to FIG. 6, the map 110 implemented in the virtual space is a classroom map, and a first trigger box T1 is placed on the classroom window side, and a second trigger box T2 is placed in the center of the classroom to distinguish the inside and the outside of the trigger box T.

Each trigger box T is matched with and stored with specialized information. In this embodiment, the specialized information of the trigger box T may include information on invisible elements related to the virtual space that the user cannot visually confirm on the map of the virtual space, that is, information that is not confirmed on the map 110. For example, the specialized information of the trigger box T may include not only visual information that the user cannot see through the virtual space implemented through the display of the user terminal 20, but also auditory, olfactory, emotional, and conceptual information.

For example, in FIG. 6, the specialized information of the trigger box T formed on the window side may include information about the scenery seen outside the window (e.g., students playing soccer on the playground), information about the smell coming through the window (e.g., the smell of dirt), information about the student in charge of cleaning the window (e.g., the window cleaner this week is Kim Cheol-soo), and the like, which the user cannot confirm on the map 110 of the virtual space. In this way, the specialized information of each trigger box T includes information about invisible elements related to the space partitioned by the trigger box T, thereby providing a more immersive and realistic response when the user converses with the character. Similarly, each trigger box T in the map 110 and the specialized information about each trigger box T may be pre-stored as information of the map 110 in the database 14 of the virtual space creation server 10.

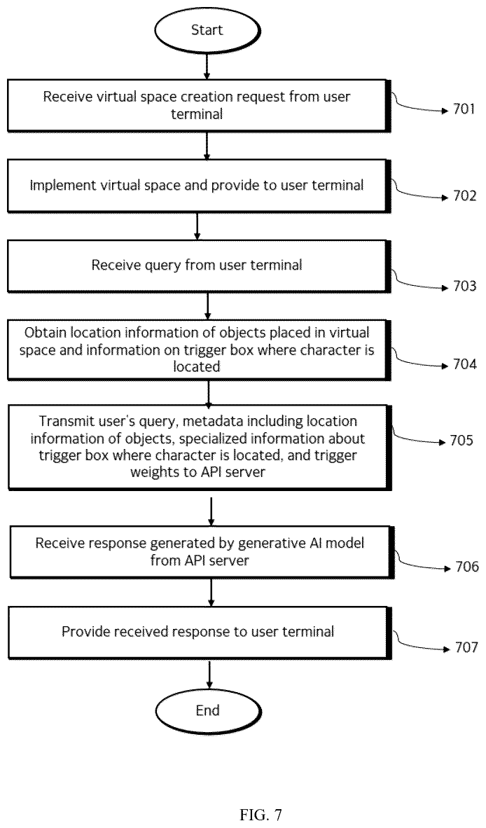

FIG. 7 is a flow chart of a dialogue generation method according to another embodiment of the present invention. Among the steps of FIG. 7, steps 701 to 703 are substantially the same as steps 301 to 303 of FIG. 3, so the description is omitted to prevent the description from becoming too long.

In step 704, the virtual space creation server 10 that received the query from the user terminal 20 in step 703 determines the location information of the character 111, object 112 and asset (114) placed in the virtual space at the time of receiving the query, and obtains information on the trigger box T where the character 111 is located based on the location information of the character 111. Referring to FIG. 6, if the character 111 is located at point (P1), the virtual space creation server 10 determines that the trigger box T where the character 111 is located does not exist, and if the character 111 is located at point (P2), the virtual space creation server 10 determines that the character 111 is located in the first trigger box T1.

At this time, the virtual space creation server 10 can determine the location of the character 111 based on the character's 111 footstep coordinates. For example, if the right arm of the character 111 is included in the second trigger box T2 and the foot of the character is included in the first trigger box T1, the virtual space creation server 10 can determine that the character is located in the first trigger box T1.

In step 705, the virtual space creation server 10 transmits metadata including location information of each object obtained in step 704 and specialized information matching the trigger box T where the character is determined to be located, together with the user's query received from the user terminal 20 in step 703, to the API server 30.

In this embodiment, the virtual space creation server 10 can determine a trigger weight indicating the proportion of the specialized information of the trigger box T reflected when the generative AI model 40 generates a response to a user's query, and transmit the determined trigger weight together with the specialized information. The API server 30 receives metadata including the location information of each object and the specialized information of the trigger box where the character is located from the virtual space creation server 10 together with the trigger weight of the specialized information, and transmits the received information together with the character's persona to the generative AI model 40, thereby allowing the generative AI model 40 to generate a richer response.

In one embodiment of the present invention, the trigger weight has a value between 0 and 1, and when the trigger weight is 0, the generative AI model 40 does not reflect any specialized information of the trigger box T at all when generating a response, and when the trigger weight is 1, the generative AI model 40 generates a response based only on the specialized information of the trigger box T when generating a response. That is, as the trigger weight approaches 1, the generative AI model 40 generates a response by reflecting more specialized information of the trigger box T where the character 111 is located. In an embodiment of the present invention, the trigger weight indicating the proportion of the reflected specialized information may indicate the proportion of the specialized information included in one response when the generative AI model 40 generates one response, or may indicate the frequency with which the specialized information is reflected when generating the response. For example, if the trigger weight is 0.8, the content related to specialized information may occupy about 80% of the entire response, or when 10 queries are received, 8 responses may be generated based on the specialized information.

In one embodiment of the present invention, the trigger weight may be determined based on the ratio of the volume included in the trigger box T where the character 111 is determined to be located among the entire volume of the character. For example, the trigger weight (Wt) may be calculated as Wt=Vc/Vt (where Vc is the volume of the character included in the trigger box where the character is located, and Vt is the entire volume of the character). For example, in FIG. 6, if the character 111 is completely inside the first trigger box T1, i.e., if the entire volume is included in the space inside the first trigger box T1, the trigger weight is 1, and if the character 111 is not located in either the first trigger box T1 or the second trigger box T2, the trigger box T where the character 111 is located is not defined, so Vb has a value of 0, and thus the trigger weight is 0. If the character 111 is determined to be located within the first trigger box T1, and 75% of the volume of the character 111 is included within the first trigger box T1 and the remaining 25% is placed in a space outside the first trigger box T1, the trigger weight is 0.75. In this case, when generating a response to a user's query, the generative AI model can generate a response based on 75% of the specialized information of the first trigger box T1 and 25% of the information in the space within the map 110 other than the first trigger box T1.

For example, if a character 111 is currently located within the first trigger box T1 and receives a question from the user terminal 20 asking, “What are you looking at right now?”, and the trigger weight is 1, then the generative AI model 40 generates a response based on the specialized information of the first trigger box T1, i.e., the first trigger box T1, that is, “I am looking at students playing soccer on the playground, sweating profusely!” If the trigger weight is 0.75, the generative AI model 40 can generate a response based on the specialized information of the first trigger box T1 and the information provided in the classroom map 110, such as “I'm watching students playing soccer outside. But isn't the classroom a bit noisy?”

In another embodiment of the present invention, the trigger weight may be calculated based on the ratio of the volume included in the trigger box T where the character 111 is determined to be located among the entire volume of the character and the ratio of the volume of the trigger box T where the character 111 is located among the entire volume of the map 110. For example, the trigger weight (Wt) may have a value of Wt=(Vc/Vt)*(1−Vb/Vm) (where, Vc is the volume of the character included in the trigger box where the character is located, Vt is the entire volume of the character, Vm is the entire volume of the map, and Vb is the entire volume of the trigger box where the character is located). This is to view a trigger box T with a small area in the entire volume of the map 110 as a space with a specific meaning in the map 110, and to reflect more specialized information of the trigger box T when a character 111 is located in a trigger box T with a small area in the entire volume of the map 110.

The API server 30, which receives a user's query from the virtual space creation server 10, metadata including location information of each object in the virtual space, and specialized information of the trigger box T where the character 111 is located and its trigger weight, transmits the persona information of the character in the virtual space together with the information received from the virtual space creation server 10 to the generative AI model 40. Accordingly, the generative AI model 40 can generate an answer that reflects the persona, location information, and specialized information of the trigger box T where the character is located in the virtual space.

In step 706, the virtual space creation server 10 receives a response generated by the generative AI model 40 based on the user's query, metadata including location information of each object, specialized information of the trigger box T where the character 111 is located, and trigger weights, transmitted in step 705, from the API server 30.

At step 707, the virtual space creation server 10 can provide the user with an experience of actually conversing with a character 111 in the virtual space by providing a response from the generative AI model 40 received at step 706 to the dialogue window of the user terminal 20.

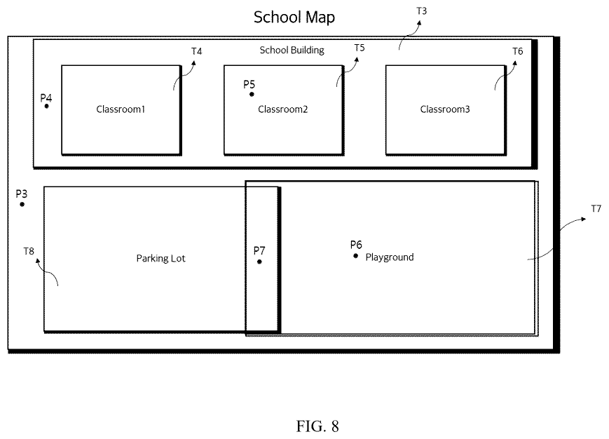

In another embodiment of the present invention, a map 110 generated by a Virtual Space Creation Server 10 may have a plurality of trigger boxes T within the map 110 that overlap at least partially with each other. FIG. 8 illustrates a map 110 provided by a Virtual Space Creation Server 10 that is partitioned by the plurality of trigger boxes T. Referring to FIG. 8, the map 110 is a school map, and a third trigger box (T3) representing a school building area within the school map, a fourth trigger box (T4), a fifth trigger box (T5) and a sixth trigger box (T6) representing each classroom that is completely included within the third trigger box (T3), a seventh trigger box (T7) representing a playground that does not overlap with the third trigger box (T3), and an eighth trigger box (T8) representing a parking lot that partially overlaps with the seventh trigger box (T7) may be included within the school map 110.

If the character is not included in any trigger box T, such as the position of point (P3) in FIG. 7, or is included in only one trigger box T, such as the positions of points (P4, P6), the trigger weight may be determined based on the ratio of the volume of the character 111 included in the trigger box T where the character 111 is located to the entire volume of the character 111, or based on the ratio of the volume included in the trigger box T where the character 111 is determined to be located to the entire volume of the character and the ratio of the volume of the trigger box T where the character 111 is located to the entire volume of the map 110.

However, if the character 111 is located at the position of the point (P5, P7) of FIG. 7, i.e., at the position where two trigger boxes or more T overlap, the trigger weight may be determined based on the volume ratio of the two trigger boxes or more T where the character 111 is located. In this embodiment, if the character 111 is located in the space where two trigger boxes or more T overlap, the trigger weight may be determined inversely proportional to the volume of each of the two trigger boxes or more T where the character 111 is located. For example, if the character is located at the point (P7) and the total volume of the seventh trigger box (T7) is three times the total volume of the eighth trigger box (T8), the trigger weight may be set to 0.25 for the specialized information of the seventh trigger box (T7) and 0.75 for the specialized information of the eighth trigger box (T8).

According to a method for generating a dialogue according to an embodiment of the present invention, when a Virtual Space Creation Server 10 receives a user's query from a user terminal 20, metadata including location information of each object, such as a character 111, an object 112, and an asset 114 placed in the virtual space at the time the query is received from the user is transmitted to the API server 30 together with the user's query, thereby obtaining a response reflecting the location of the character 111 in the virtual space, allowing for a richer and more immersive dialogue experience for the user.

Meanwhile, even if all the components constituting the embodiments of the present invention are described as being combined or operated in combination, the present invention is not necessarily limited to these embodiments. That is, within the scope of the purpose of the present invention, all the components may be selectively combined and operated in one or more. In addition, although all the components may be implemented as independent hardware, some or all of the components may be selectively combined and implemented as a computer program having a program module that performs some or all of the functions combined in one or more hardware. The codes and code segments constituting the computer program may be easily inferred by a person skilled in the art of the present invention. Such a computer program may be stored in a non-transitory computer readable medium and read and executed by a computer, thereby implementing the embodiments of the present invention.

Here, the non-transitory readable recording medium means a medium that stores data semi-permanently and can be read by a device, rather than a medium that stores data for a short period of time, such as a register, cache, or memory. Specifically, the programs described above can be stored and provided on non-transitory readable recording media such as a CD, DVD, hard disk, Blu-ray disc, USB, memory card, or ROM.

Although the preferred embodiments of the present invention have been illustrated and described above, the present invention is not limited to the specific embodiments described above, and various modifications may be made by those skilled in the art without departing from the spirit of the present invention as claimed in the claims. Furthermore, such modifications should not be understood individually from the technical idea or prospect of the present invention.

### DESCRIPTION OF SYMBOLS

1: Dialogue Generation System
10: Virtual Space Creation Server
20: User Terminal
30: API Server
40: Generative AI Model

What is claimed is:

1. A method for generating a dialogue, comprising:
generating a virtual space in which a character and objects are placed in a map and providing it to a user terminal;
receiving a user's query targeting the character from the user terminal;
obtaining location information of the character and objects placed in the virtual space at the time of receiving the user's query;
transmitting metadata including the obtained location information of the character and objects together with the user's query to an API server;
receiving a response to the user's query from the API server; and
providing the received response to the user terminal,
wherein the response is generated by a generative AI model that receives the user's query, the metadata, and persona information of the character from the API server, thereby being based on the location information of the character in the virtual space.

2. The method for generating a dialogue according to claim 1, further comprising:
determining a trigger box in which the character is located based on the obtained location information of the character,
wherein the internal space of the map of the virtual space is partitioned by at least one trigger box having a rectangular box shape,
wherein the specialized information of the trigger box where the character is determined to be located is transmitted to the API server together with the user's query and the metadata,
wherein the response is generated by the generative AI model that receives the user's query, the metadata, the persona information of the character, and the specialized information of the trigger box in which the character is located from the API server, thereby being based further on the specialized information of the trigger box in which the character is located.

3. The method for generating a dialogue according to claim 2, wherein the specialized information of the trigger box includes information about invisible elements associated with the internal space of the trigger box that cannot be visually confirmed on the map of the virtual space.

4. The method for generating a dialogue according to claim 3, further comprising:
determining a trigger weight that indicates the extent to which the specialized information of the trigger box, in which the character is located, is reflected when generating the response by the generative AI model,
wherein the determined trigger weight is transmitted to the API server together with the specialized information of the trigger box in which the character is located.

5. The method for generating a dialogue according to claim 4, wherein the trigger weight is determined based on a ratio of the total volume of the character and the volume of the character included in the trigger box in which the character is located.

6. The method for generating a dialogue according to claim 5, wherein the trigger weight is determined further based on a ratio of the entire volume of the map and the volume of the trigger box in which the character is located.

7. The method for generating a dialogue according to claim 4, wherein the internal space of the map of the virtual space is partitioned by two trigger boxes or more, at least two of which overlap each other, and in determining the trigger box in which the character is located based on the obtained character location information, if it is determined that the character is located in an overlapping area of at least two trigger boxes, the trigger weight for the specialized information of each trigger box in which the character is located is determined inversely proportional to the volume of each trigger box in which the character is located.

8. A dialogue generation system, comprising:
a virtual space creation server configured to create a virtual space in which a character and objects are placed and provide it to a user terminal, and when receiving a user's query targeting the character from the user terminal, obtain location information of the character and objects at the time of receiving the user's query, and transmit metadata including the location information of the character and objects obtained together with the user's query to an API server;
an API server configured to transmit the user's query received from the virtual space creation server and the metadata including the location information of the character and objects to a generative AI model together with persona information of the character; and
a generative AI model configured to generate a response to the user's query based on the user's query, the metadata, and the persona information of the character received from the API server, and return the generated response to the API server.
